(19) United States
(12) Patent Application Publication
(10) Pub. No.: US 2019/0007270 A1
(43) Pub. Date: Jan. 3, 2019

(54) DEPLOYING QoS POLICIES IN INTERFACES OF NETWORK DEVICES

(71) Applicant: Hewlett Packard Enterprise Development LP, Houston, TX (US)

(72) Inventors: Shiva Prakash Suragi Math, Bangalore Karnataka (IN); Anuradha Venkataraman, Bangalore Karnataka (IN); Venkatesh Raman Ramteke, Bangalore Karnataka (IN)

(21) Appl. No.: 15/974,736

(22) Filed: May 9, 2018

(30) Foreign Application Priority Data
Jun. 29, 2017 (IN) 201741022782

(51) Int. Cl. H04L 12/24; H04L 12/851; H04L 12/26

(52) U.S. Cl. CPC H04L 41/0893; H04L 41/0896; H04L 43/08; H04L 47/2425; H04L 41/5003

(57) ABSTRACT

Examples relate to deploying QoS policies in interfaces of network devices of a network. A full traffic matrix of a network is obtained by monitoring network traffic in a set of interfaces of a set of network devices of the network, wherein network traffic is generated by application. A required bandwidth for each application in each interface in the network is determined based on a priority assigned to the applications. A set of interfaces among all the interfaces of the network are identified for deploying a QoS policy. The QoS policy to be deployed in each interface is determined based on an IT policy of the network. Lastly, the determined QoS policies are deployed into the set of interfaces of the network.

### BACKGROUND

In computer networking, Quality of Service (QoS) may refer to traffic prioritization and resource reservation control mechanisms to ensure that the performance of applications is not impacted due to the network performance. QoS may be the ability to provide different priority to different applications, users, or data flows, or to guarantee a certain level of performance to a data flow. To quantitatively measure QoS, several related aspects of the network service may be often considered, such as error rates, bit rate, throughput, transmission delay, availability, jitter, etc.

### BRIEF DESCRIPTION OF THE DRAWINGS

Features of the present disclosure are illustrated by way of example and not limited in the following figure(s), in which like numerals indicate like elements, in which:

FIG. 1 is a flowchart of an example method for deploying QoS policies in a set of interfaces of a set of network devices of a network.

FIG. 2 is a flowchart of an example method for building the traffic matrix of a network.

FIG. 3 is a flowchart of an example method for recalculating the path confidence rating for each monitored application passing through the network.

FIG. 4 is a block diagram of an example network to implement the method for deploying QoS policies in a set of interfaces of a set of network devices of the network.

FIG. 5 is a block diagram of a portion of the example network of FIG. 4 including the application path confidence rating for application “File I/O”. FIG. 5A is a block diagram of the portion of the example network including the application path confidence rating for application “File I/O” between interface A and interfaces B and E. FIG. 5B is a block diagram of the portion of the example network including the application path confidence rating for application “File I/O” between interfaces A and Output1. FIG. 5C is a block diagram of the portion of the example network 400 including the application path confidence rating for application “File I/O” between interfaces A and Output1 to which reverse probability has been applied.

FIG. 6 is a block diagram of an example network of FIG. 4 in which the application path confidence rating has been recalculated considering historical bandwidth utilization of applications at network interfaces. FIG. 6A is a block diagram of the example network 400 including the application path confidence rating of application “AppServer” between interfaces C and output2. FIG. 6B is the block diagram of FIG. 6A including the recalculated application path confidence rating of application “AppServer” considering historical bandwidth utilization of applications at network interfaces.

FIG. 7 is a table showing the full traffic matrix of the network of FIG. 4.

FIG. 8 is a block diagram of an example QoS deploying engine.

### DETAILED DESCRIPTION

End-to-End QoS (E2E QoS) may ensure that business applications have the required share of network resources to achieve their business goals, thus minimizing the impact of unexpected burst in some category of traffic on business performance. E2E communications may refer to communications between end systems through a computing network. E2E networked applications may refer to applications performing E2E communications through the computing network and the E2E QoS may refer to the QoS policies that may be defined and deployed on devices of the computing network to ensure the achievement of a certain level of performance of application or a data flow. Some examples of communication parameters related to the QoS are a bit rate, delay, jitter, packet loss, bit error rates, among others.

As generally described herein, an application may be a program designed to perform a specific function directly for the user or, in some cases, for another application. Examples of applications may include word processors, database programs, web browsers, development tools, drawing, paint, image editing programs, and communication programs. Applications may use the services of the computing device's operating system and other supporting applications.

Computing networks may be configured to ensure that the performance of applications whose packets flow through network devices of the computing network (also named as nodes in the network) is not impacted due to the computing network performance. Thus, the computing networks, and more particularly the network devices forming the computing networks, may be configured to provide appropriate priority and resources to ensure the correct functioning of the applications. When network devices are configured, the traffic density of various applications whose packets flow through the network devices may be considered and the corresponding configuration may be adapted accordingly.

Therefore, an adequate configuration of the network devices may allow to provide a differential treatment to the different types of applications using the computing network. These network configurations enable differential treatment for various types of applications. However, when the performance of the computing network is analyzed and subsequent adaptations are done manually by network administrators, the scope for errors and sub-optimal configurations is extremely high. One badly or sub-optimally configured network device is sufficient to degrade the performance of the applications through the entire network and then, the business goals may not be achieved.

In order to configure the network devices, QoS policies may be deployed on the network devices, such as routers or switches. These QoS policies may be configurable and their configuration may allow network administrators to categorize and prioritize the traffic flowing through the network devices, and more generally, through the network. However, in most of cases the QoS policies may be deployed only on the edge devices of the network or may not be deployed at all. Alternatively, the network administrators may overprovision the network by deploying the QoS policies in a number of network devices higher than necessary, which may result in an inefficient management of the network resources. Besides, network administrators may deploy the same QoS policy in some or all the network devices of the network. Using the same QoS policy template for all the interfaces in a network, without customizing a particular QoS policy for a particular network device depending on the applications passing through said network device and the network segment to which is to service, may result in an inadequate configuration of the network devices.

Moreover, tools for instrumenting the network, that provide the ability to collect IP network traffic as it enters or exits an interface and that allow to derive information from the network such as the source and destination of traffic, class of service, and the causes of congestion, may fully instrument the network (by instrumenting all the interfaces in all the network devices of the network) to build a full traffic matrix that is used to obtain the QoS policy definitions. However, these tools may generate a huge amount of flows at each of the interfaces in the network which require massively scalable hardware and software devices to handle the flows across the network.

Further, when business capacity is expanded or additional applications are added, the incremental network capacity required to ensure performance is very often derived by intuition and experimentation rather than scientifically-backed extrapolation of the traffic patterns in the network.

To address these issues, examples described herein may refer to methods for deploying QoS policies in a particular set of interfaces of a particular set of network devices in a computing network. The methods may comprise obtaining, by a QoS deploying engine, a full traffic matrix of a network by monitoring network traffic in a set of interfaces of a set of network devices of the network. This network traffic may be generated by applications. Then, the QoS deploying engine may determine a required bandwidth for each application passing through each one of the interfaces in the network based on a priority assigned to the applications. The priority assigned to each one of the applications may be, for example, deployed by an IT administrator and be based on an Information Technology (IT) policy of the network. The QoS deploying engine may further identify a set of interfaces among all the interfaces of the network device in the network for deploying a QoS policy. The particular set of interfaces in which deploying the QoS policy may be the interfaces where a sum of the required bandwidth for the applications passing through the interfaces is higher than the total available bandwidth in the particular interface or the interfaces through which network traffic of applications passing through is not controlled via a QoS policy in an upstream interface. The QoS deploying engine may further determine the QoS policy to be deployed in each interface based on an IT policy of the network. The IT policy may be provided by the IT administrator or network manager. Lastly, the QoS deploying engine may deploy the QoS policy into the set of interfaces of the network.

As used herein an interface is a system's (software, hardware or a combination of both) interface between two pieces of equipment, network devices or protocol layers in a computing network. An interface may have a network address such as a node ID and a port number or may be a unique node ID in its own right. Interfaces may further provide standardized functions such as passing messages, connecting and disconnecting, etc. Examples of interfaces may be a computer port (an interface to other network devices or peripherals), a network interface controller (the device a computer uses to connect to a computer network), a network interface device (a demarcation point for a telephone network), a network socket (a software interface to the network) a computing networking port (a protocol interface to the network), etc. One network device may comprise at least one interface to interact with other network devices within the same network or with elements external to the network.

As generally described herein, a traffic matrix may represent the volume of data traffic between all possible pairs of sources and destinations in a given IP domain, such as a network. The traffic matrix may further represent the amount of data transmitted between every pair of network nodes, peak traffic or traffic at a specific time.

In some examples, the QoS deploying engine, for obtaining the full traffic matrix of the network, may determine a set of interfaces to be monitored among all the interfaces of the network. The QoS deploying engine may determine the set of interfaces by selecting those interfaces in the network having a bandwidth utilization over a pre-defined and user-configurable threshold. In some other examples, the QoS deploying engine may determine the set of interfaces by selecting those interfaces which may be monitored in the network for other purposes. Then, the QoS deploying engine may obtain a total bandwidth utilization for the non-monitored interfaces in the network. The non-monitored interfaces may be all the interfaces in the network that have not been previously determined to be monitored. Further, the QoS deploying engine may determine an application path confidence rating for each application in the network. Since the full traffic matrix provides the destinations for the data traffic of the applications and considering the routes that the traffic flow may take to reach the respective destinations, the QoS deploying engine may calculate a path confidence rating for each application in the network.

Lastly, the QoS deploying engine may determine a number of additional interfaces to be monitored based on the application path confidence rating of the applications. The number resulting of the sum of the set of interfaces previously determined to be monitored and the additional interfaces to be monitored, is the minimum number of interfaces at which QoS policies may be deployed that assures a correct performing of the applications. Thus, this minimum number of interfaces may allow to achieve an adequate QoS E2E in the network. In some other examples, these selected interfaces may be the minimum number of interfaces at which network traffic pattern is to be monitored to build the full traffic matrix of the network.

In some other examples, the QoS deploying engine may determine, for each monitored interface, a list of applications whose packets pass through the interface. Then, the QoS deploying engine may determine a destination network device for the network traffic of each application passing through the interface. After that, the QoS deploying engine may determine a bandwidth utilization for each application at the interface and a next hop for the network traffic of each application that is passing through the interface. Lastly, the QoS deploying engine may determine a total bandwidth utilization at the interface.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

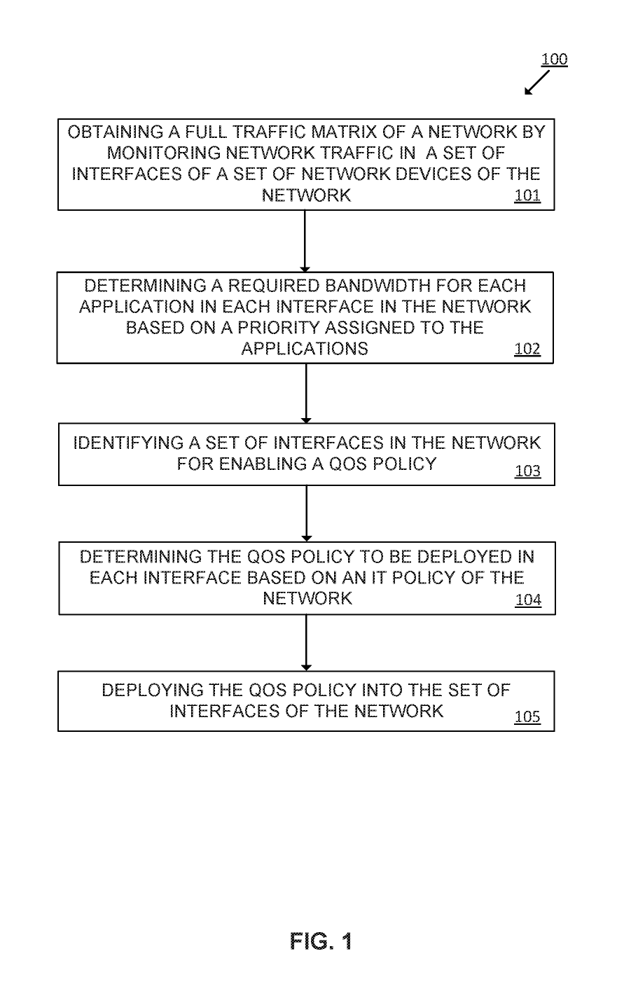

Turning now to the figures, FIG. 1 is a flowchart of an example method 100 for deploying QoS policies in a set of interfaces of a set of network devices of a network. Implementation of this method 100 is not limited to such example.

At 101 of the method 100, the QoS deploying engine obtains a full traffic matrix of a network by monitoring the network traffic in a set of interfaces of a set of network devices of the network. This network traffic is generated by applications using the network. Obtaining the full traffic matrix of the network may comprise discovering, by the QoS deploying engine, the network by building the network topology. The discovering process may further comprise discovering the applications whose packets pass through the network, the bandwidth utilization in the interfaces of the network and the interfaces that are already being monitored in the network for other purposes. In some other examples, the QoS deploying engine may comprise an instrumentation engine to collect IP network traffic as it enters or exits the monitored interfaces and that allow to derive information from the network such as the source and destination of traffic, class of service, etc. The instrumentation engine may include hardware and software logic to perform the described functionalities.

At 102 of the method 100, the QoS deploying engine determines a required bandwidth for each application in each interface in the network based on a priority assigned to the applications. This priority may be pre-assigned by automatically classifying all the applications using the network based on a predefined application class hierarchy assigned by an IT administrator or network manager. In some other examples, the QoS deploying engine may determine the required bandwidth for each application in each interface in the network based a service-level agreement assigned to the applications instead of the priority. In some other examples, determining the required bandwidth for each application in each interface in the network may comprise obtaining a peak bandwidth utilization for each application and assigning a risk buffer to each interface based on the priority of the applications passing through the interface. The risk buffers may allow to temporarily store data from respective application until it is forwarded to the next network device in the network. For example, risk buffers having greater lengths may be assigned to applications with higher priorities.

At 103 of the method 100, the QoS deploying engine identifies a set of interfaces among all the interfaces of the network for deploying a QoS policy. These interfaces may be selected as the interfaces where a sum of the required bandwidth for the applications passing through the interfaces is higher than a total available bandwidth in the particular interface or the interfaces through which network traffic of applications passing through is not controlled via a QoS policy in an upstream interface. The upstream interface may be another interface of a network device through which the application's packets have passed immediately prior to reach the current interface.

At 104 of the method 100, the QoS deploying engine determines the QoS policy to be deployed in each interface based on an IT policy of the network. For example, the QoS deploying engine may translate the IT policy into a QoS policy by determining an application-class mapping and an application-priority mapping to each application passing through the network and determining an action to be performed with network traffic of the applications. In some examples, the application-class mapping may comprise categorizing applications by assigning a class to each application flowing through a particular interface examples of classes are gold class, silver class, etc. In some other examples, the application-class mapping may comprise assigning a class to a type of service, such as voice service, image service, etc., in order to assign a class to the applications providing a particular service. By way of example, the applications providing a voice service may be assigned with a gold class while applications providing a writing service may be assigned with a silver class. The class may be assigned to the application, in some other examples, based on the IT policy. In turn, the application-priority mapping may comprises categorizing applications by assigning a priority to each application. This priority may have been pre-assigned by the IT administrator or network manager.

In some examples, the action to be performed with the application's packets may be based on the priority assigned to the application. Examples of these actions may be dropping packets from applications with a low priority, temporary queuing packets from high priority applications in buffers until having available bandwidth in the interface to route them to their destination, etc.

The QoS policy to be deployed in the interfaces may comprise the parameters to configure said interfaces that ensure an adequate performance of the applications though the network and that, therefore, ensure achieving the E2E QoS. Examples of these configuration parameters are the class name of the applications passing through the interfaces, the bandwidth capacity assigned in the interfaces to each application, the priority assigned to the applications, the actions to be performed in the interfaces based on the priority assigned to the applications, etc.

At 105 of the method 100, the QoS deploying engine deploys the previously determined QoS policy into the previously determined set of interfaces of the network devices in the network.

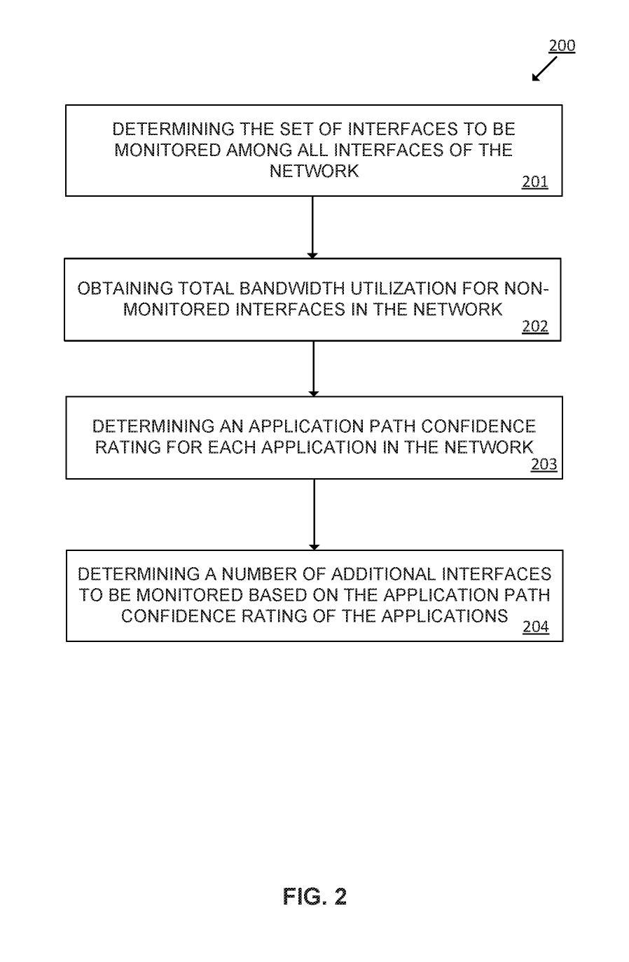

FIG. 2 is a flowchart of an example method 200 for obtaining the full traffic matrix of a network. Implementation of this method 200 is not limited to such example.

At 201 of the method 200, the QoS deploying engine determines a particular set of interfaces to be monitored among all the interfaces of the network. For example, the QoS deploying engine may determine the set of interfaces to be monitored by selecting the interfaces having bandwidth utilization higher than a pre-defined threshold, by selecting the interfaces already being monitored in the network or by selecting a combination of both. In some examples, the QoS deploying engine may identify the applications whose packets pass through each interface of the particular set of interfaces. Then the QoS deploying engine may further determine the destination network device for the network traffic of each application passing through the interface. This destination may be obtained from the full traffic matrix of the network previously calculated.

In some examples, determining the particular set of monitored interfaces may further comprise, for each one of the interfaces of the network, determining, by the QoS deploying engine, a list of applications whose packets pass through the interface. The QoS deploying engine may determine a destination network device for the network traffic of each application passing through the interface. Then, the QoS deploying engine may determine a bandwidth utilization for each application at the interface, a next hop for the network traffic of each application that is passing through the interface and a total bandwidth utilization at the interface. All this information may be obtained by the QoS deploying engine from the traffic matrix of the network previously calculated.

At 202 of the method 200, the QoS deploying engine obtains a total bandwidth utilization for the non-monitored interfaces in the network. This total bandwidth utilization of the non-monitored interfaces in the network may be obtained from the previously obtained full traffic matrix of the network.

At 203 of the method 200, the QoS deploying engine determines an application path confidence rating for each application in the network. The application path confidence rating may be determined in terms of the probability of network traffic from an application to utilize a specific path. The application path confidence rating may be, for example, a numeric value between 0 and 1.

At 204 of the method 200, the QoS deploying engine determines a number of additional interfaces to be monitored based on the application path confidence rating of the applications. The QoS deploying engine may select, among all the non-previously monitored interfaces, those interfaces receiving traffic flow from more than one application and whose traffic flow has passed through more than one monitored interfaces as the additional interfaces to be monitored.

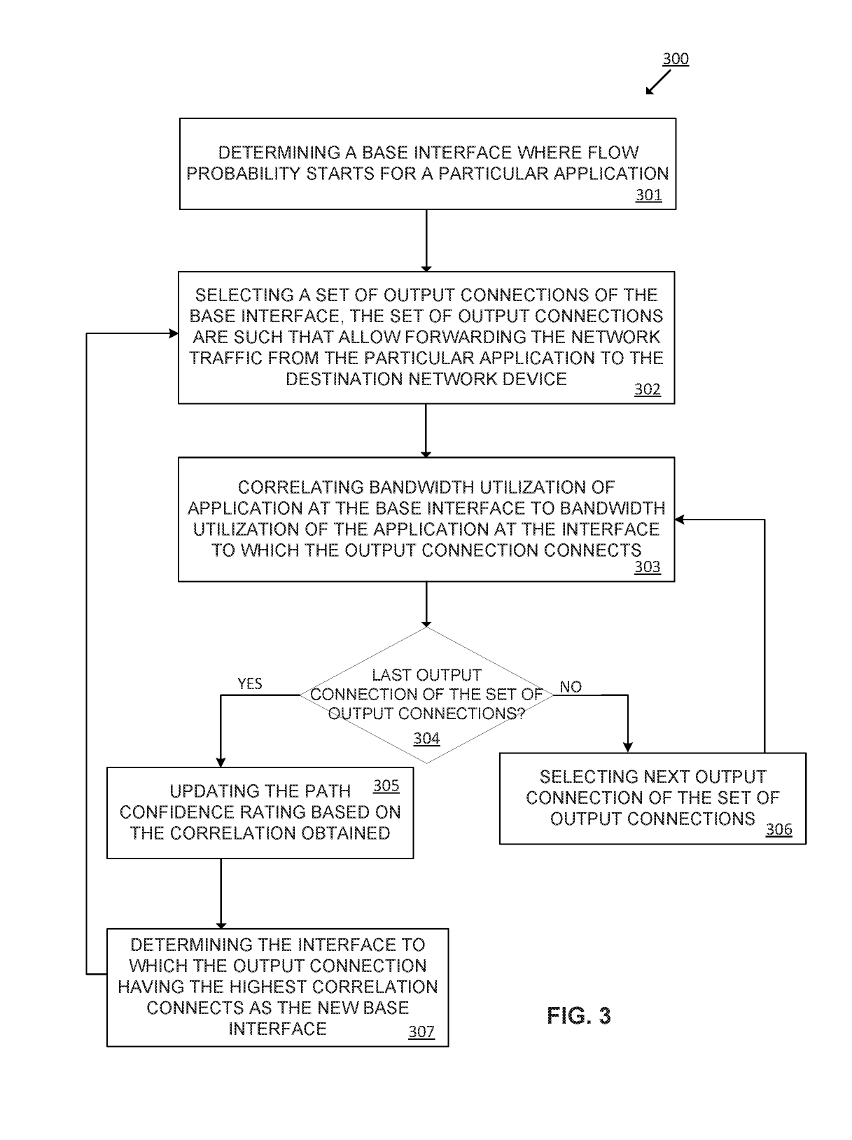

FIG. 3 is a flowchart of an example method 300 for recalculating the application path confidence rating for each monitored application passing through the network. Implementation of this method 300 is not limited to such example.

In order to improve the application path confidence rating calculated for each application in the network, the QoS deploying engine determines 301 a base interface in the network where flow probability starts for a particular application. Then, the QoS deploying engine selects 302 a set of output connections among all output connections of the base interface with other interfaces in the network, wherein the set of output connections are such that allow forwarding the network traffic of the application to the destination network device.

After that, the QoS deploying engine, for each output connection of the set of output connections, correlates 303 the bandwidth utilization of the application at the base interface to the bandwidth utilization of the application at the output connection. Correlation works by adding up one-or-more application utilization to match up against output connection utilization. This allows to determine which application contributes towards output connection input flow. The QoS deploying engine checks 304 whether the base interface has additional output connections not already correlated. If there are additional output connections, then the QoS deploying engine selects 306 these additional output connections and performs the correlation step 303. If there are not additional output connections to be correlated, the QoS deploying engine updates the application path confidence rating based on the correlation obtained.

Lastly, the QoS deploying engine determines 307 the interface connecting to the base interface through the path having the highest application path confidence rating as the new base interface and executes steps 302-306 until arriving to the destination network device.

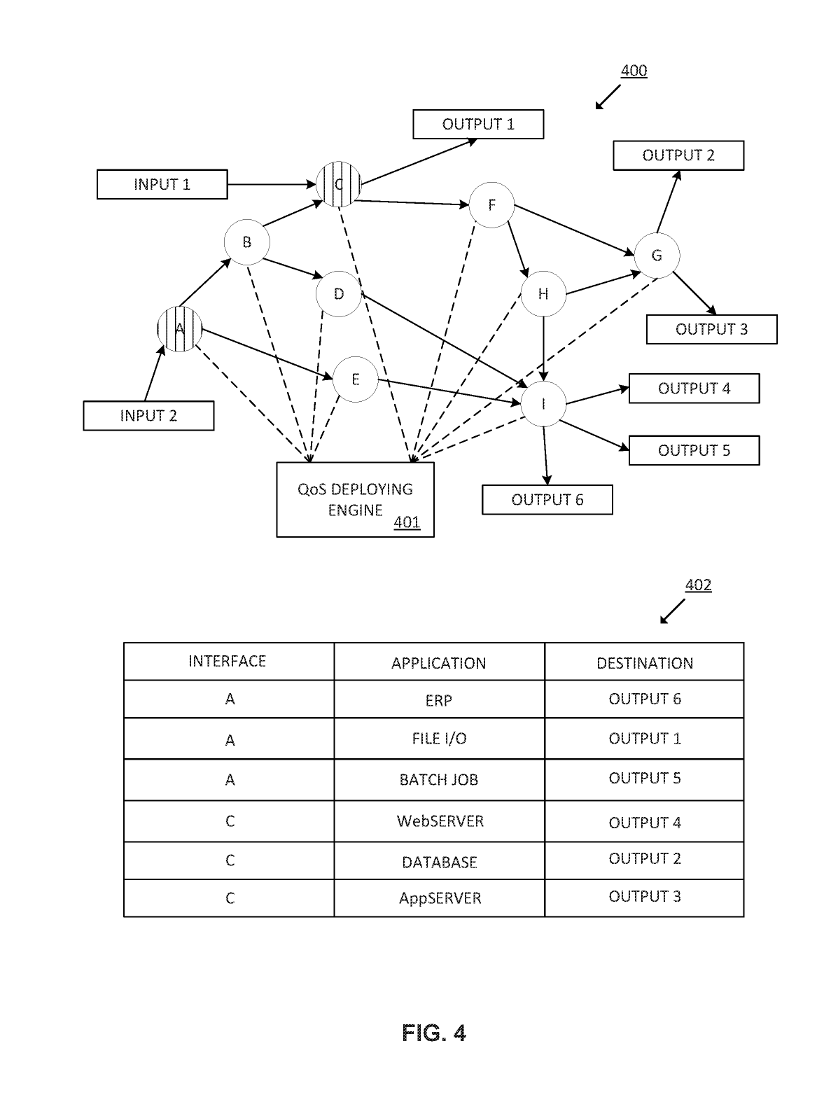

FIG. 4 is a block diagram of an example network 400 to implement the method for deploying QoS policies in a set of interfaces of a set of network devices of the network 400. It should be understood that the network 400 depicted in FIG. 4 may include additional components and that some of the components described herein may be removed and/or modified without departing from a scope of the example network topology 400.

The network 400 comprises a plurality of network devices, in particular, network devices A-I. The network devices may be any electronic device able to route packets through the network, for example routers, switches or a combination of both. In this example there are two input flows, inputs1-2, that comprise network traffic generated by a plurality of applications. In particular, input1 enters the network 400 through an ingress port of network device C and input2 enters the network 400 through an ingress port of network device A. While in the example network topology of FIG. 4 each network device has one single interface, interfaces A-I, the network devices may have any number of interfaces to interact with other devices in the network 400.

The QoS deploying engine 401 may monitor the network traffic at any of interfaces A-I to build the network topology by performing a discovering process of the network 400. As shown in the example of FIG. 4, the QoS deploying engine 401 may monitor interfaces A and C to obtaining a list of all applications whose packets are passing through interfaces A and C, the destination IP address of the interface for each of the applications, a bandwidth utilization for each of the applications at the interface A and C, interface detail for application network traffic's next hop and the total bandwidth utilization at interfaces A and C.

The network 400 further comprises six outputs, outputs1-6, for network traffic flowing through the network 400. In particular, output 1 may be reached through interface C, outputs2-3 may be reached through interface G, and outputs4-6 may be reached through interface I. In such example, outputs1-6 are also interfaces of respective devices which are not part of the network 400. The arrows in the example network 400 show the direction of the network traffic flow.

As shown in the example table of FIG. 4, interface A receives network traffic from applications: Enterprise Resource Planning (ERP) application, File I/O application and Batch Job application. Network traffic generated by ERP application has output6 as its destination, network traffic generated by File I/O application has output1 as its destination and network traffic generated by Batch Job application has output5 as its destination. Interface C receives network traffic from: WebServer application, DataBase application and AppServer application. Network traffic generated by WebServer application has output4 as its destination, network traffic generated by DataBase application has output2 as its destination and network traffic generated by AppServer application has output3 as its destination.

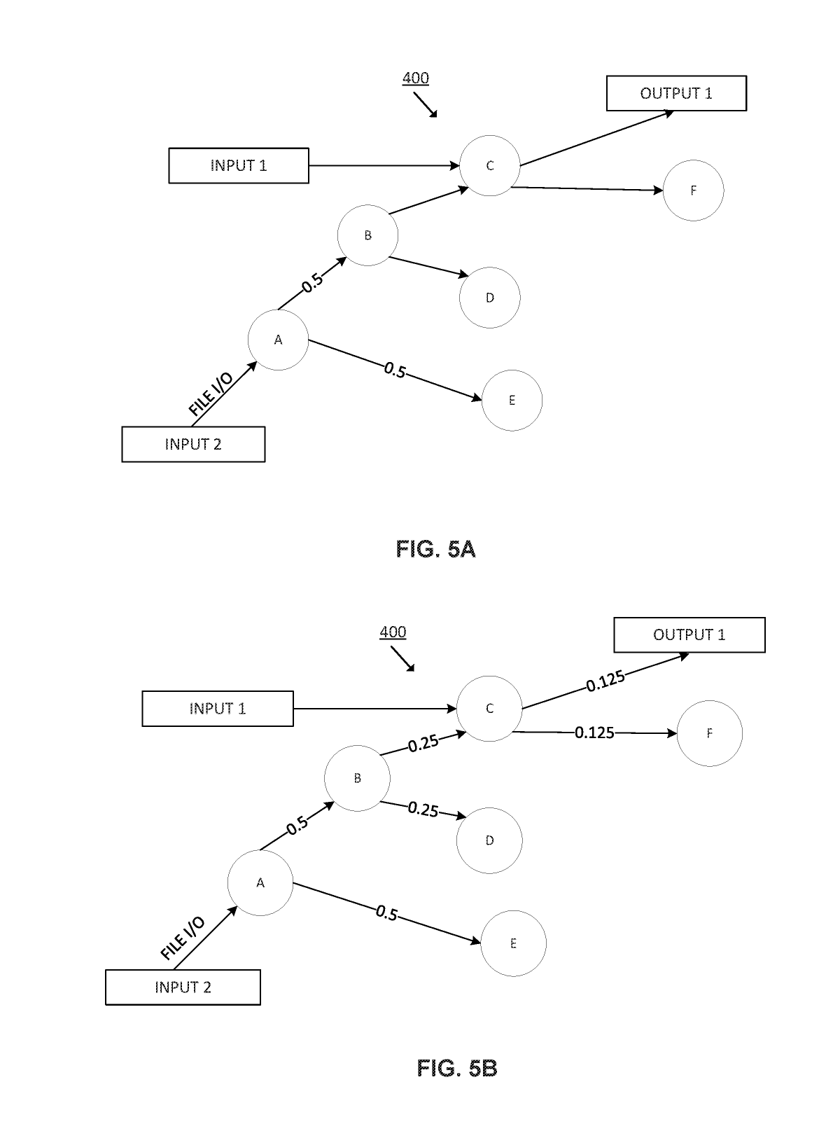

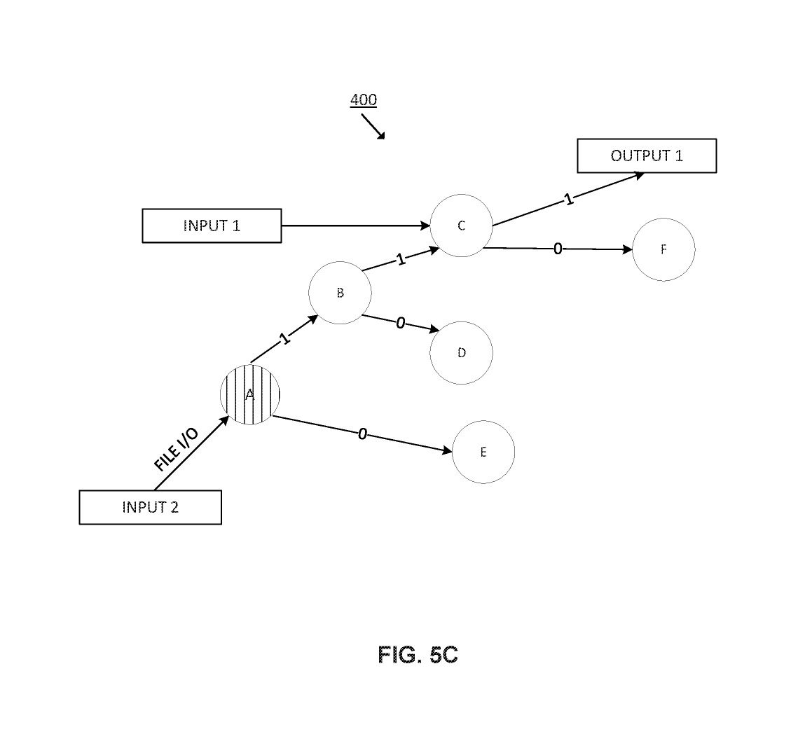

FIG. 5 is a block diagram of a portion of the example network 400 of FIG. 4 including the application path confidence rating for application “File I/O”. It should be understood that the portion of the example network shown in FIG. 5 may include additional components and that some of the components described herein may be removed and/or modified without departing from a scope of the example portion of the example network.

Although FIG. 5 shows a portion of the application path confidence rating for application “File I/O” passing through monitored interface A, the application path confidence rating is to be calculated for all the discovered applications passing through the monitored interfaces. The application path confidence rating is determined in terms of probability of application data flow utilizing a specific path.

FIG. 5A is a block diagram of the portion of the example network 400 including the application path confidence rating for application “File I/O” between interface A and interfaces B and E. Based on the available network topology, a probability of path flow is assigned for each application based on information derived from the full traffic matrix previously obtained. For example, application “File I/O” passing through interface A and having output1 as its destination may be routed, as a first hop, to interfaces B or E with the same probability. Thus, the QoS deploying engine may assign an application path confidence rating of “0,5” to the two possible paths because the probability of network traffic from application “File I/O” to utilize the path between interface A and interface B or the path between interface A and interface E is the same.

FIG. 5B is a block diagram of the portion of the example network 400 including the application path confidence rating for application “File I/O” between interfaces A and Output1.

Once the application path confidence rating has been calculated for the first hop of the route (paths between interfaces A-B,D), the QoS deploying engine may propagate this application path confidence rating across the network 400 until reaching the destination interface (output1). In such example, the application path confidence rating is divided by the number of interfaces involved in each hop. For example, the QoS deploying engine may divide the application path confidence rating received at interface B by the number of paths through which the network traffic may be routed towards output1. Thus, an application path confidence rating of “0,25” may be assigned by the QoS deploying engine to the paths between interfaces B and C and B and D. This division is performed again to reach output 1, assigning the QoS deploying engine an application path confidence rating of “0,125” to the paths between interfaces C and output1 and C and F.

In some other examples, instead of dividing the application path confidence rating by the number of interfaces involved in each hop, the QoS deploying engine may add the application path confidence rating, and thus the probability of network traffic from an application to use a particular path, of each incoming interface path.

FIG. 5C is a block diagram of the portion of the example network 400 including the application path confidence rating for application “File I/O” between interfaces A and Output1 to which reverse probability has been applied.

Considering that the destination of the network traffic from application “File I/O” is interface output1, the QoS deploying engine applies reverse probability starting from output1 such that those paths not allowing to reach the destination are reassigned with an application path confidence rating of “0”, while those paths of the route allowing to reach the destination interface are assigned with an application path confidence rating of “1”. This strengths the probability of path flow for the applications and allows to assign probability of interfaces even when the interfaces are not monitored for traffic. Therefore, the application path confidence rating is only assigned for paths which have reachability to the destination interfaces.

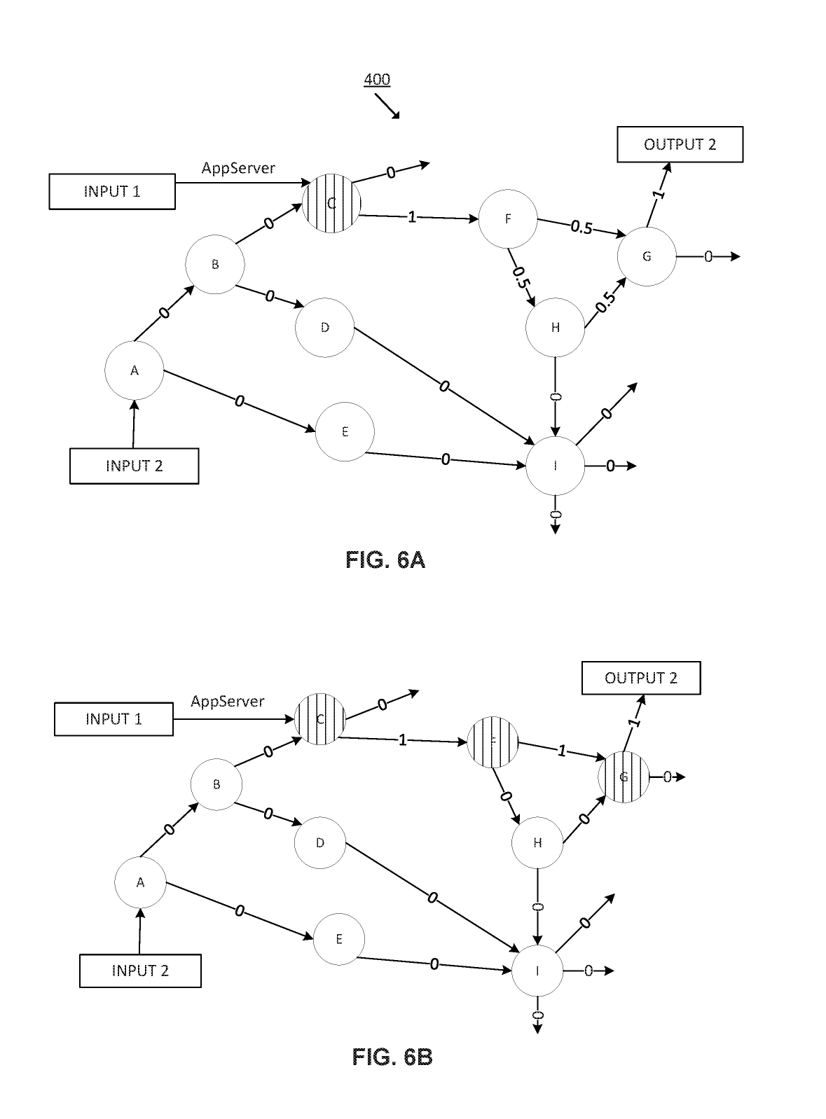

FIG. 6 is a block diagram of an example network of FIG. 4 in which the application path confidence rating has been recalculated considering historical bandwidth utilization of applications at network interfaces. It should be understood that the example network 400 shown in FIG. 6 may include additional components and that some of the components described herein may be removed and/or modified without departing from a scope of the network 400.

FIG. 6A is a block diagram of the example network 400 including the application path confidence rating of application “AppServer” between interfaces C and output2. In such example, the application path confidence rating for application “AppServer” has been calculated as explained in FIG. 5. In particular, application “AppServer” enters to the network through interface C and have output2 as its destination. The QoS deploying engine has assigned an application path confidence rating of “1” to the path between interface C and interface F, an application path confidence rating of “0.5” to the paths between interfaces F and H, H and G and F and G, an application path confidence rating of “1” to the path between interfaces G and output2 and an application path confidence rating of “0” to the rest of paths in the network 400.

Then, the QoS deploying engine selects interface C as the base interface in the network 400 where flow probability starts for application “AppServer”. The QoS deploying engine further determines all output connections for interface C, these output connections being determined as the paths where reachability for application “AppServer” towards output2 exists within the selected output connections.

In such example, the only output connection for interface C is the output connection with interface F, interface F being named as the “output interface”.

After that, the QoS deploying engine, for each output interface of the base interface, obtains the total bandwidth utilization at said output interface. In such example, the QoS deploying engine obtains the total bandwidth utilization at interface F. Then, the QoS deploying engine correlates the total bandwidth utilization of applications at the base interface against total bandwidth utilization at the output interface. Specifically, the QoS deploying engine correlates the total bandwidth utilization at interface C against total bandwidth utilization at interface F. Since interface F is the only output interface for interface C, the QoS deploying engine determines that the application path confident rating is “1” for the path connecting both interfaces.

Then, the QoS deploying engine determines interface F as the new base interface and correlates the total bandwidth utilization of applications at interface F against total bandwidth utilization at respective output interfaces G and H. Then, the QoS deploying engine selects the output interface having a highest correlation value as the new base interface and assigns an application path confidence rating of “1” to the path joining both interfaces, and an application path confidence rating of “0” to the rest of paths connecting to the other output interfaces. Thus, for those base interfaces having more than one output interfaces, the QoS deploying engine will correlate the total bandwidth utilization of the base interface with each one of the output interfaces and then select the output interface having the highest correlation value as the interface to which assign a highest application path confidence rating. In some examples, the QoS deploying engine may assign an application path confidence rating of “1” to the path connecting the base interface with the output interface having the highest correlation and an application path confidence rating of “0” to the rest of paths connecting to the rest of output interfaces.

FIG. 6B is the block diagram of FIG. 6A including the recalculated application path confidence rating for application “AppServer” considering historical bandwidth utilization of applications at network interfaces. Based on the recalculated application path confidence rating for all the applications passing through the monitored interfaces and the network topology obtained from the discovering process of the network 400, the QoS deploying engine may obtain the full traffic matrix of the network 400.

Recalculating, for each application passing through the monitored interfaces, the application path confidence rating in the network 400 using statistical analysis of historical bandwidth utilization until arriving to the destination interface improves reliability of the network.

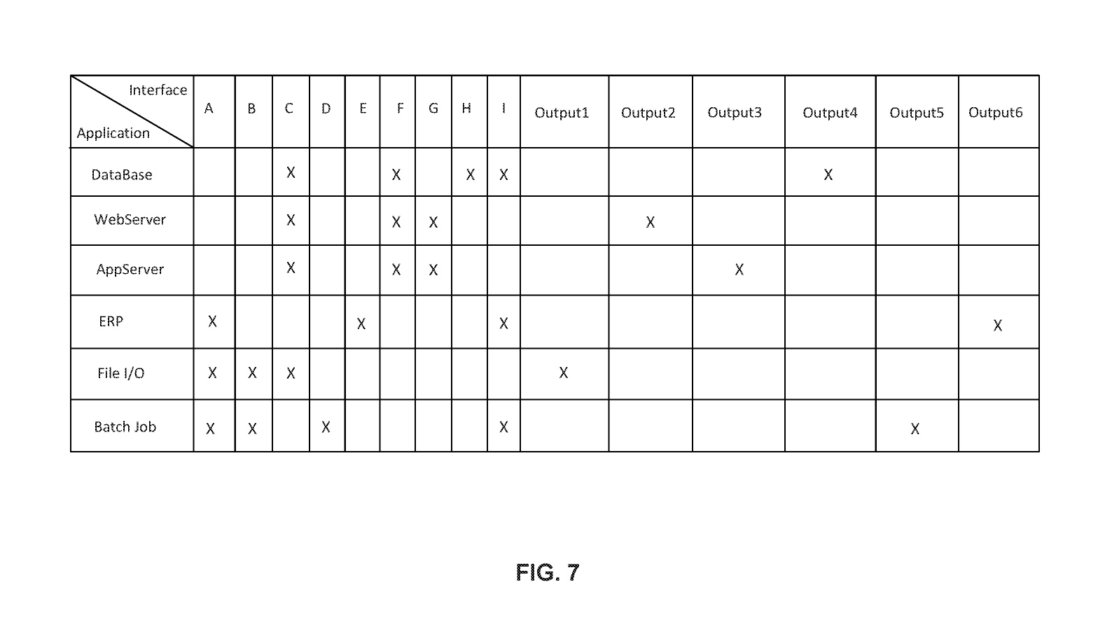

FIG. 7 is a table showing the full traffic matrix of the example network 400 of FIG. 4. The table shows the interfaces the traffic flow generated by the applications pass through.

The QoS deploying engine determines an additional number of interfaces to be monitored based on the obtained full traffic matrix of the network 400. Then, the QoS deploying engine analyzes the full traffic matrix and identifies the interfaces, other than previously monitored interfaces A and C, that are shared by more than one application and wherein the network traffic received from the applications sharing the interface also passes through more than one monitored interface. In such example, interface I receives network traffic originated by applications ERP and Batch Job that are monitored through interface A, and by application DataBase that is monitored through interface C. Thus, network traffic received at interface I is generated by three applications and this traffic has more than one parent monitoring interface. The rest of interfaces or are not shared by more than one application or the received network traffic has not more than one parent monitoring interfaces. Hence, Interface I becomes the logical interface for additional traffic monitoring. Thus, the number resulting of the sum of the set of interfaces previously determined to be monitored, interfaces A and C, and the additional interfaces to be monitored, interface I, is the minimum number of interfaces at which QoS policies may be deployed that assures a correct performing of the applications. In such example, the minimum number of interfaces is three. Monitoring these three interfaces allows to achieve an adequate QoS E2E in network 400.

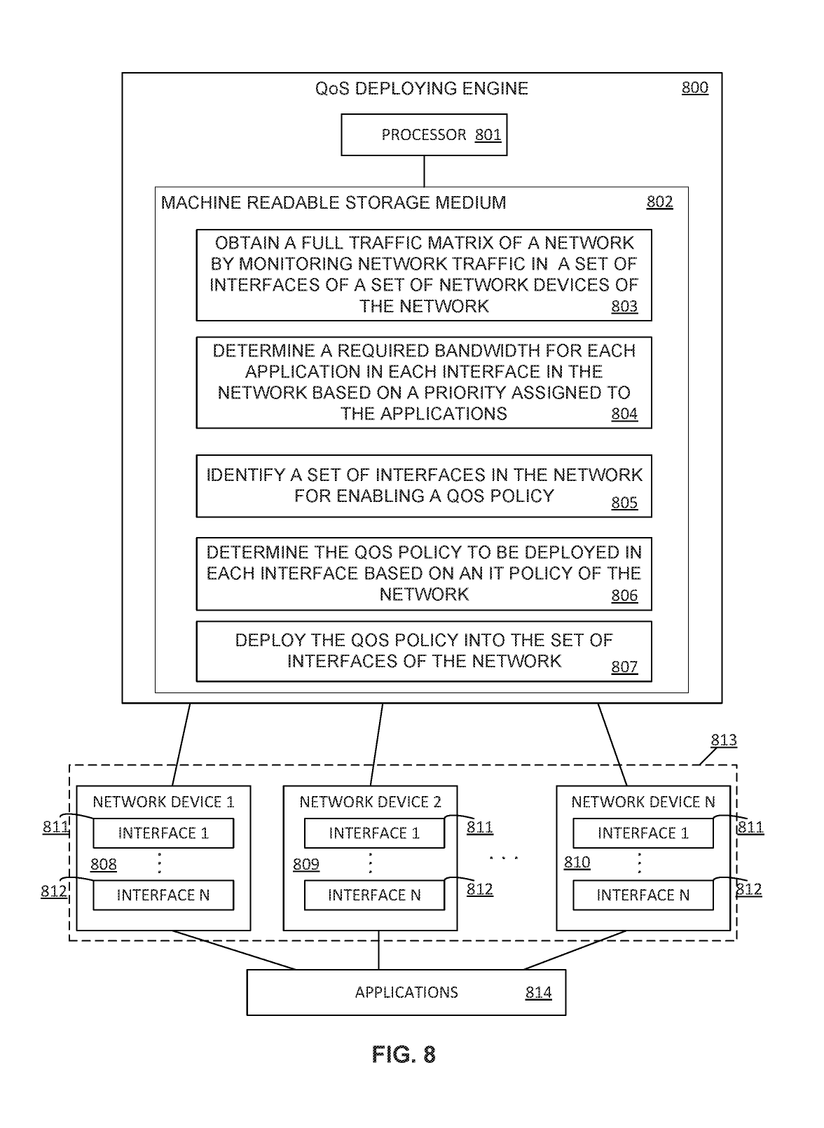

FIG. 8 is a block diagram of an example QoS deploying engine 800 in which a machine-readable storage medium 802 stores instructions to be executed by a processor 801 of the QoS deploying engine 800. It should be understood that the QoS deploying engine 800 depicted in FIG. 8 may include additional components and that some of the components described herein may be removed and/or modified without departing from a scope of the example QoS deploying engine 800. Additionally, implementation of QoS deploying engine 800 is not limited to such example. It should also be understood that QoS deploying engine 800 may represent a combination of hardware and software logic for deploying QoS policies in a set of interfaces 811-812 of a set of network devices 808-810 of a network 813.

The QoS deploying engine 800 is depicted as including a machine-readable storage medium 802 and a processor 801. Each network device 808-810 may have any number of interfaces 811-812 to interact with other devices in the network 813. Moreover, the network devices 808-810 may receive network traffic from any number of applications 814.

In such example, the QoS deploying engine 800 obtains 803 a full traffic matrix of the network 813 by monitoring the network traffic in a set of interfaces of a set of network devices of the network 813. This network traffic is generated by the applications 814 using the network. Then, the QoS deploying engine 800 determines 804 a required bandwidth for each application 814 in each interface 811 in the network based on a priority assigned to the applications. This priority may be pre-assigned by automatically classifying all the applications using the network based on a predefined application class hierarchy assigned by an IT administrator or network manager. The QoS deploying engine 800 further identifies 805 a set of interfaces among all the interfaces of the network for deploying a QoS policy. These interfaces may be selected as the interfaces where a sum of the required bandwidth for the applications passing through the interfaces is higher than a total available bandwidth in the particular interface or the interfaces through which network traffic of applications passing through is not controlled via a QoS policy in an upstream interface.

The QoS deploying engine 800 determines 806 the QoS policy to be deployed in each interface based on an IT policy of the network. For example, the QoS deploying engine 800 may translate the IT policy into a QoS policy by determining an application-class mapping and an application-priority mapping to each application passing through the network and determining an action to be performed with network traffic of the applications. Lastly, the QoS deploying engine 800 deploys 807 the previously determined QoS policy into the previously determined set of interfaces of the network devices in the network.

The QoS deploying engine 800 may include hardware and software logic to perform the functionalities described above in relation to instructions 803-807. The machine-readable storage medium 802 may be located either in the computing device executing the machine-readable instructions, or remote from but accessible to the computing device (e.g., via a computer network) for execution.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

The deployment of QoS policies in the interfaces of the network devices of a network as described herein improves the end to end quality of service of an application by considering business priorities.

1. A method comprising:
obtaining, by a Quality of Service (QoS) deploying engine, a full traffic matrix of a network by monitoring network traffic in a set of interfaces of a set of network devices of the network, wherein network traffic is generated by applications;
determining, by the QoS deploying engine, a required bandwidth for each application in each interface in the network based on a priority assigned to the applications;
identifying, by the QoS deploying engine, a set of interfaces among all the interfaces of the network for deploying a QoS policy as the interfaces where a sum of the required bandwidth for the applications passing through the interfaces is higher than a total available bandwidth in the particular interface or the interfaces through which network traffic of applications passing through is not controlled via a QoS policy in an upstream interface;
determining, by the QoS deploying engine, the QoS policy to be deployed in each interface based on an IT policy of the network; and
deploying, by the QoS deploying engine, the QoS policy into the set of interfaces of the network.

2. The method of claim 1, wherein obtaining the full traffic matrix of the network comprises:
determining a set of interfaces to be monitored among all the interfaces of the network;
obtaining a total bandwidth utilization for the non-monitored interfaces in the network;
determining an application path confidence rating for each application in the network; and
determining a number of additional interfaces to be monitored based on the application path confidence rating of the applications.

3. The method of claim 2, wherein determining the set of interfaces to be monitored among all interfaces of the network comprises, for each interface of the set of interfaces:
determining a list of applications whose packets pass through the interface;
determining a destination network device for the network traffic of each application passing through the interface;
determining a bandwidth utilization for each application at the interface;
determining a next hop for the network traffic of each application that is passing through the interface; and
determining a total bandwidth utilization at the interface.

4. The method of claim 2, comprising recalculating the application path confidence rating for each application based on the bandwidth utilization for each application at the interface and the total bandwidth utilization for interfaces at non-monitored interfaces in the network.

5. The method of claim 4, wherein recalculating the application path confidence rating for each application comprises:
a) determining a base interface where flow probability starts for a particular application;
b) selecting a set of output connections among all output connections of the base interface wherein the set of output connections are such that allow forwarding the network traffic from the particular application to the destination network device;
c) for each output connection of the set of output connections, correlating the bandwidth utilization of the application at the base interface to the bandwidth utilization of the application at the output connection;
d) updating the application path confidence rating based on the correlation obtained; and
e) determining the interface through which the output connection having the highest application path confidence rating connects to the base interface as the new base interface and executing steps b)-e).

6. The method of claim 1, wherein determining a required bandwidth in the set of interfaces for each application based on a priority assigned to the applications comprises using a service-level agreement instead of the priority.

7. The method of claim 1, wherein determining the required bandwidth for each application in each interface in the network comprises:
obtaining a peak bandwidth utilization for each application; and
assigning a risk buffer to each interface based on the priority of the applications passing through the interface.

8. The method of claim 1, wherein determining the QoS to be deployed in each interface comprises translating the IT policy into a QoS policy by determining an application-class mapping and an application-priority mapping to each application passing through the network and determining an action to be performed with network traffic of the applications, the action being based on the priority of the application.

9. The method of claim 1, wherein the QoS to be deployed in the interfaces comprises, for each application passing through a particular interface, a class name of the application, a required bandwidth for the application, an action to be performed with network traffic of the application and a priority for the application.

10. A non-transitory machine readable storage medium comprising instructions executable by a Quality of Service (QoS) deploying engine to:
obtain a full traffic matrix of a network by monitoring network traffic in a set of interfaces of a set of network devices of the network, wherein network traffic is generated by applications;
determine a required bandwidth for each application in each interface in the network based on a priority assigned to the applications;
identify a set of interfaces among all the interfaces of the network for deploying a Quality of Service (QoS) policy as the interfaces where a sum of the required bandwidth for the applications passing through the interfaces is higher than a total available bandwidth in the particular interface or the interfaces through which network traffic of applications passing through is not controlled via a QoS policy in an upstream interface;
determine the QoS policy to be deployed in each interface based on an IT policy of the network; and
deploy the QoS policy into the set of interfaces of the network.

11. The non-transitory machine readable storage medium of claim 10, wherein the instructions to obtain the full traffic matrix of the network further comprise instructions to:
determine a set of interfaces to be monitored among all the interfaces of the network;
obtain a total bandwidth utilization for the non-monitored interfaces in the network;
determine an application path confidence rating for each application in the network; and
determine a number of additional interfaces to be monitored based on the application path confidence rating of the applications.

12. The non-transitory machine readable storage medium of claim 11, wherein the instructions to determine the set of interfaces to be monitored among all interfaces of the network further comprise, for each interface of the set of interfaces, instructions to:
determine a list of applications whose packets pass through the interface;
determine a destination network device for the network traffic of each application passing through the interface;
determine a bandwidth utilization for each application at the interface;
determine a next hop for the network traffic of each application that is passing through the interface; and
determine a total bandwidth utilization at the interface.

13. The non-transitory machine readable storage medium of claim 12, wherein the instructions to obtaining the full traffic matrix of the network further comprises instructions to recalculate the path confidence rating for each monitored application based on the bandwidth utilization for each application at the interface and the total bandwidth utilization for interfaces at non-monitored interfaces in the network.

14. The non-transitory machine readable storage medium of claim 13, wherein the instructions to recalculate the path confidence rating for each monitored application further comprise instructions to:
a) determine a base interface where flow probability starts for a particular application;
b) select a set of output connections among all output connections of the base interface wherein the set of output connections are such that allow forwarding the network traffic from the particular application to the destination routing device;
c) for each output connection of the set of output connections, correlate the bandwidth utilization of application at the base interface in the network to the bandwidth utilization of application at the interface to which the output connection connects;
d) update the path confidence rating based on the correlation obtained;
e) determine the interface to which the output connection connects as the base interface and executing steps b)-e).

15. A network comprising:
a plurality of network devices, the network devices comprising a set of interfaces; and
a Quality of Service (QoS) deploying engine connected to the network devices, wherein the QoS deploying engine is to:
obtain a full traffic matrix of a network by monitoring network traffic in a set of interfaces of a set of network device among all the network devices of the network, wherein network traffic is generated by applications;
determine a required bandwidth for each application in each interface in the network based on a priority assigned to the applications;
identify a set of interfaces among all the interfaces of the network for deploying a Quality of Service (QoS) policy as the interfaces where a sum of the required bandwidth for the applications passing through a particular interface is higher than a total available bandwidth in the particular interface or where network traffic of applications passing through the particular interface is not controlled via a QoS policy in an upstream interface;
determine the QoS policy to be deployed in each interface based on an IT policy of the network; and
deploy the QoS policy into the set of interfaces of the network.
